(19) United States
(12) Patent Application Publication
(10) Pub. No.: US 2015/0012550 A1
(43) Pub. Date: Jan. 8, 2015

(54) SYSTEMS AND METHODS OF MESSAGING DATA ANALYSIS

(71) Applicant: XEROX CORPORATION, Norwalk, CT (US)

(72) Inventors: Veerasundaravel THIRUGNANASUNDARAM, Webster, NY (US); Tong Sun, Penfield, NY (US); David R. Vandervort, Walworth, NY (US); Arun Bakthavachalu, Webster, NY (US)

(21) Appl. No.: 13/936,737

(22) Filed: Jul. 8, 2013

(51) Int. Cl. G06F 17/30

(52) U.S. Cl. CPC G06F 17/30943
USPC 707/755

(57) ABSTRACT

Systems and methods of analyzing message data. An embodiment is a method of analyzing message data including a plurality of messages associated with one or more users. The method is performed using a computing system comprising a computer storage medium and a computer processor. The system parses each message of the plurality of messages to identify a plurality of message segments. The system assigns the message segments to the one or more users. The assignment is based at least in part on a determination of whether each message of the plurality of messages is a reply message. The segments of the message are assigned to a reply user if the message is determined to be a reply message. The system applies a statistical model to the assigned message segments, to determine predicted locations for the users. The system outputs the predicted locations for the users.

### TECHNICAL FIELD

This disclosure relates to systems and methods of data analysis, and in particular automated analysis of network messaging data.

### BACKGROUND

Social networking and micro blogging services have opened new possibilities for use as human-powered sensing networks. Users may use these services to talk about their daily activities and to seek or share information. This growth has spurred an interest in using the data provided by these platforms for extracting certain information, such as geographic location, from its users. The information obtained can be used to provide users with personalized services, such as local news, local advertisements, application sharing, and so on. Given the popularity of such services, the numerous messages posted therein form a huge data set that can be analyzed to extract such geographic and other information.

Some of these services allow for users to self-identify their locations, but analysis of these self-provided locations can be of limited value. Among other things, users may provide ambiguous location data (e.g., specifying “Washington” without identifying whether it refers to the state or city), fictitious location data, location data too broad to be of analytical value (e.g., specifying “United States”), multiple locations, and so on. Accordingly, personalized services based on these self-reported locations may be inaccurately targeted or otherwise ineffective.

### SUMMARY

Accordingly, disclosed in various embodiments are systems and methods of determining locations and/or other information based on analysis of messaging data from social networking services, microblogging services, and other such sources. Although the disclosure focuses on determinations of locations, it will be understood that the systems and methods disclosed herein may be applied to determinations of other relevant information, such as user interests, demographics, consumer habits, activities, and the like.

An embodiment is a method of analyzing message data including a plurality of messages associated with one or more users. The method is performed using a computing system comprising a computer storage medium and a computer processor. The system parses each message of the plurality of messages to identify a plurality of message segments. The system assigns the message segments to the one or more users. The assignment is based at least in part on a determination of whether each message of the plurality of messages is a reply message. The segments of the message are assigned to a reply user if the message is determined to be a reply message. The system applies a statistical model to the assigned message segments, to determine predicted locations for the users. The system outputs the predicted locations for the users.

Optionally in any of the aforementioned embodiments, parsing each message of the plurality of messages to identify a plurality of message segments comprises identifying one or more words of the plurality of messages.

Optionally in any of the aforementioned embodiments, identifying one or more words of the plurality of messages comprises canonicalizing at least one word of the one or more words.

Optionally in any of the aforementioned embodiments, the determination of whether each message of the plurality of messages is a reply message comprises determining whether the message includes a reply tag within the text of the message.

Optionally in any of the aforementioned embodiments, the determination of whether the message includes a reply tag comprises identifying a user identification symbol within the message.

Optionally in any of the aforementioned embodiments, the segments of the message are assigned to the author of the message if the message is determined not to be a reply message.

Optionally in any of the aforementioned embodiments, the statistical model comprises a plurality of distribution values associating message segments with locations.

Optionally in any of the aforementioned embodiments, applying the statistical model to the assigned message segments comprises computing an aggregated distribution value based on a subset of the plurality of distribution values associated with the assigned message segments.

Optionally in any of the aforementioned embodiments, at least one of the subset of the plurality of distribution values is associated with a message segment identified in a reply message.

Optionally in any of the aforementioned embodiments, the statistical model is computed based on a training dataset comprising training users, training messages, and training locations.

Optionally in any of the aforementioned embodiments, the training locations include latitude and longitude coordinates.

Optionally in any of the aforementioned embodiments, the training locations are determined to be obtained from a computer-generated source rather than from a user-provided source.

Optionally in any of the aforementioned embodiments, the statistical model is computed based at least in part on a maximum likelihood estimation.

Optionally in any of the aforementioned embodiments, outputting the predicted locations for the users comprises presenting targeted advertising to the users based at least in part on the predicted locations.

An embodiment is a computer system configured to analyze messages. The computer system includes a computer storage medium having stored thereon a plurality of messages associated with one or more users. The computer system includes a computer processor configured to execute one or more software modules. The computer system includes a parsing module configured to parse each message of the plurality of messages to identify a plurality of message segments. The computer system includes an assignment module configured to assign the message segments to the one or more users. The assignment is based at least in part on a determination of whether each message of the plurality of messages is associated with an associated user. The segments of the message are assigned to the associated user if the message is determined to be associated with the associated user. The computer system includes a statistical modeling module configured to apply a statistical model to the assigned message segments, to automatically generate predictions for the users. The computer system includes an output module configured to output the predictions for the users.

An embodiment is a non-transitory computer-readable medium having stored thereon a plurality of executable software modules configured to be executed on a computer system having a computer processor. A parsing module is configured to parse each message of a plurality of messages to identify a plurality of message segments. An assignment module is configured to assign the message segments to one or more users. The assignment is based at least in part on a determination of whether each message of the plurality of messages is associated with an associated user. The segments of the message are assigned to the associated user if the message is determined to be associated with the associated user. A statistical modeling module is configured to apply a statistical model to the assigned message segments, to automatically generate predictions for the users. An output module is configured to output the predictions for the users.

### BRIEF DESCRIPTION OF THE DRAWINGS

FIG. 1 is a block diagram of a computer system including messaging data analysis modules, as used in an embodiment.

FIG. 2 is a block diagram of data structures of user and message objects, as used in an embodiment.

FIG. 3 is a flowchart of a process of analyzing messaging data, as used in an embodiment.

FIG. 4 is a flowchart of a process of analyzing messages, incorporating relationships among messages, as used in an embodiment.

FIG. 5 is a graph of experimental data assessed from an implementation of the algorithms described in this specification.

FIG. 6 illustrates a computer system that is consistent with embodiments of the present teachings.

### DESCRIPTION OF THE EMBODIMENTS

For simplicity and illustrative purposes, the principles of the present teachings are described by referring mainly to exemplary embodiments thereof. However, one of ordinary skill in the art would readily recognize that the same principles are equally applicable to, and can be implemented in, all types of systems, and that any such variations may be included in various embodiments. Moreover, in the following detailed description, references are made to the accompanying figures, which illustrate specific embodiments. Electrical, mechanical, logical and structural changes can be made to various embodiments. It will be understood that the embodiments disclosed may be varied, augmented, or altered, that elements may be exchanged with their equivalents, and that elements may be implemented in many different ways.

Generally, the systems and methods described below relate to analysis of message data. The data may originate from a social networking system, a microblogging system, an email system, an instant messaging system, and/or other system with messages and/or similar data. A common, though non-limiting, example of such a system is the microblogging service Twitter, in which users may post messages called “tweets” on a website. In general, such messaging systems maintain a set of users, and those users generate messages with text. However, it is understood that alternate embodiments need not be limited to human users and text messages. For example, in alternate embodiments, computer messages may be analyzed, and the messages may include images, video, audio, computer code, and so forth. The systems and methods described herein may be performed on a portion of the messaging system itself, and/or on an external system, using imported and/or network-transmitted data for example.

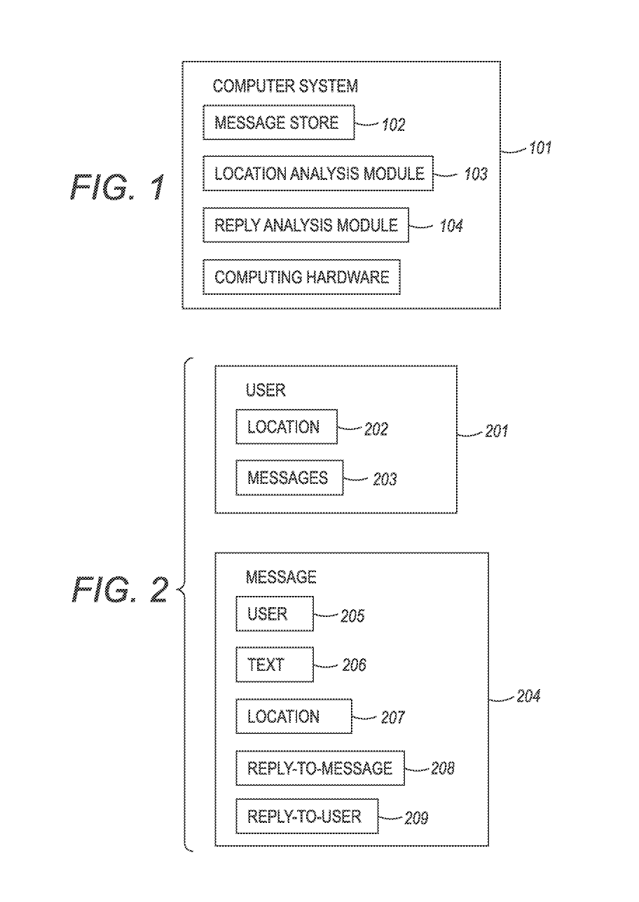

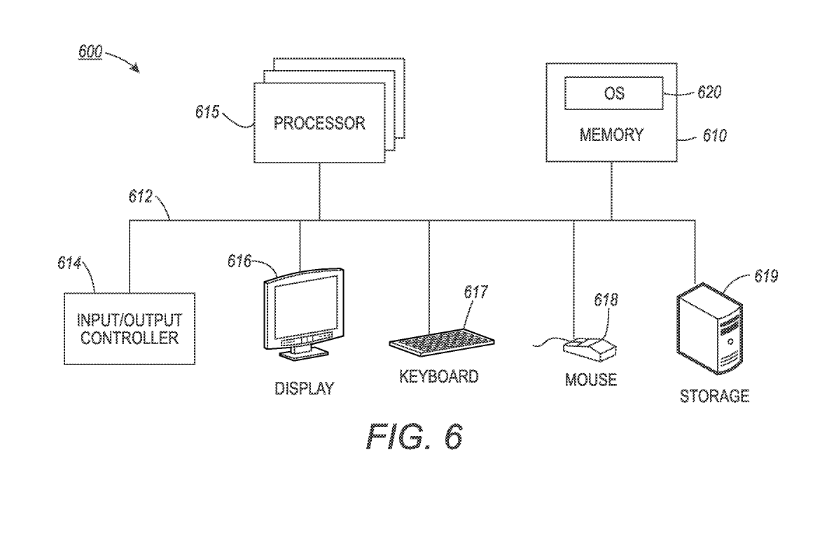

FIG. 1 is a block diagram of a computer system including messaging data analysis modules, as used in an embodiment. The computer system may include further elements and/or any subset of the elements shown, and those elements may be arranged differently from the presented arrangement. The elements may be implemented as hardware components such as electronic circuitry, and/or as software modules stored on computer storage media such as volatile memory and/or nonvolatile storage. The computer system may include one or more computer devices, such as those described with respect to FIG. 6.

Computer system 101 may include one or more modules 102-104 for analysis of messaging data, in an embodiment. Message store module 102 may maintain and/or store messaging data to be analyzed. The stored data may include testing data used in constructing one or more statistical or predictive models. The stored data may further include analysis data to be applied to the one or more statistical or predictive models. Message store module 102, and/or other modules, may be configured to receive, accept, and/or store further data, possibly via a network connection or other external data source. Message store module 102, and/or other modules, may additionally or alternatively present one or more user interfaces and/or application programming interfaces configured to receive, accept, and/or store data.

Location analysis module 103 may be configured to determine location information relating to users. The determination may be based on data from message store module 102 and/or other data, possibly including data provided by an operator of computer system 101 and/or other users. Reply analysis module 104 may be configured to analyze messages, such as those maintained by message store module 102, and the relation of those messages to each other. The relation between messages that is considered in this disclosure is the relation of a reply message, in which one message is a reply to another. However, it will be understood that other message relations may be identified and/or considered by reply analysis module 104 and/or other modules or aspects of computer system 101.

FIG. 2 is a block diagram of data structures of user and message objects, as used in an embodiment. The data structures may be stored on computer-readable media such as a hard drive, SSD, tape backup, distributed storage, cloud storage, and so on, and may be structured as relational database tables, flat files, C structures, programming language objects, database objects, and the like. Elements of the data structures may be arranged differently in various embodiments, elements may be added and/or removed, and related elements may be associated through references, pointers, links, substructures, foreign keys, and so on.

Generally, two types of data structures are described with respect to FIG. 2. First, user data structures represent users of a messaging system, and message data structures represent messages posted by those users. User data structure 201 may include one or more data fields and/or references. For example, user data structure 201 may include a location data field 202. The location may be represented in various forms, such as a text field, a structured field (e.g., address, city, and state), geospatial coordinates, and the like. The user data structure 201 may further include references to one or more messages 203 posted by the user.

Message data structure 204 may similarly include one or more data fields and/or references. For example, user field 205 may identify the user who posted the message, and text field 206 may include the text and/or other information included in the message. Location 207 may identify a location associated with the message. It may be advantageous to associate locations with users (as in field 202) and/or messages (as in field 207), for example to account for the fact that users may post messages from different locations, and in various embodiments both, either, or none of these fields may be included.

As explained previously, messages may be related to each other, for example by being replies to other messages. This may be represented in one or more data structure fields. For example, reference 208 may identify another message for which message 204 is a reply. Messages may, in an embodiment, be in reply to a user generally rather than a particular message, and this may be represented by reference 209, which may identify a user to which message 204 is directed. Although reply references 208 and 209 are depicted as separate fields in message data structure 204, it will be understood that they may be implemented by various mechanisms in various embodiments. For example, message text 206 may identify a reply-to message and/or reply-to user through special encodings, such as a user name appended to an “at” symbol (“@”).

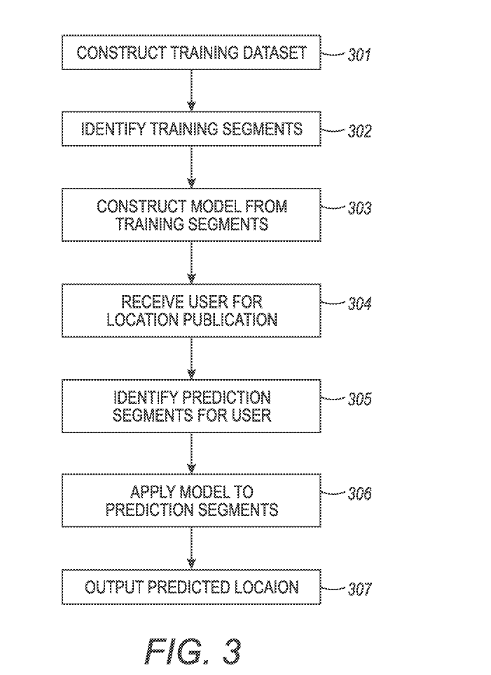

FIG. 3 is a flowchart of a process of analyzing messaging data, as used in an embodiment. The method may be performed by a computer system such as system 101 of FIG. 1. In various embodiments, additional blocks may be included, some blocks may be removed, and/or blocks may be connected or arranged differently from what is shown.

Of the process described with respect to FIG. 3, blocks 301-303 may represent a “training phase” in which one or more probabilistic, statistical, and/or predictive models are built; and blocks 304-307 may represent an “analysis phase” in which those models are applied to generate predicted information. These two phases may be conducted at different times and/or on different computing systems, in various embodiments.

At block 301, a training dataset may be constructed. The training dataset may include messaging data, which may be structured as data structures 201 and 204, for example. The training dataset may further include dependent variable data for prediction, such as location data. This dependent variable data may be used in fitting one or more models to the dataset.

In an embodiment, the training dataset is based on a sample of active users with over a minimum number (e.g., 1,000) of messages and who have listed their locations in the form of latitude/longitude coordinates. Since these types of user-submitted locations may be generated by reliable methods such as GPS-enabled smartphones, they may be used for accurate training of statistical and/or predictive models. Known techniques may be used to filter out undesired messaging data (such as spam messages and/or automatically generated messages). In an embodiment, a sufficiently large training dataset is employed to provide greater statistical significance; for example, a set of 5000 users and 5 million messages may be used as a training dataset.

At block 302, the system may identify one or more segments from the training dataset. The segments may be appropriately selected analytical elements derived from the messages in the training dataset. In an embodiment, the segments are individual words of the message texts, and although the remainder of the disclosure focuses on word-based analysis, it will be understood that other types of segments may be employed, such as groups of words (shingles, common phrases, etc.), image hashes, metadata, and the like. Furthermore, segments may be processed into canonical or other useful forms. For example, for word-based segments, certain words may be excluded (e.g., through a word stoplist), and/or different tenses, conjugations, and/or declensions of words may be coalesced (e.g., “surfed,” “surfing,” “surfer,” etc. may be combined with “surf”).

At block 303, the system may construct a probabilistic, statistical, predictive, and/or other model, based on the training segments of block 302, the location data and/or dependent variable data, and/or other information such as additional independent variables. One type of model, referred to here as the “baseline estimation model,” is described in detail below. However, it will be understood that the methods described below can be applied with respect to numerous other modeling techniques, such as linear regression, nonlinear regression, neural networks, genetic algorithms, and so on.

In the baseline estimation model, each user is treated as belonging to a particular city or other locational scope, so that their messages are associated with that city. The words (or other analytical segments) of the user's messages can be assigned as relating to the user's city. This may form a basic distribution of location terms for the set of cities considered in the complete data set.

In an embodiment, the actual distribution across cities for each word in the sampled dataset is identified. Based on maximum likelihood estimation, Bayesian analysis, and/or other methods, the probabilistic distribution over cities for word w can be formalized as P(i|ω) which identifies for each word ω the likelihood that it was issued by a user located in city i. For example, the word “surf” may tend to occur frequently with users in Santa Cruz. Users from cities other than Santa Cruz may also post messages with the word “surf,” so reliance on a single word or a single message may reveal very little information about the true location of a user. Thus, the degree of reliability by which a word indicates one or more locations may be determined according to statistical or other algorithms. Further aggregation of multiple words in messages posted by a user may provide a stronger indication of the location of that particular user.

The process of the embodiment of FIG. 3 next turns to the analysis phase. At block 304, a user is identified for prediction of that user's location and/or other information. The user's messages and/or other information may be gathered and processed into segments, such as canonicalized words, at block 305. These words or other segments may then be applied to one or more statistical, predictive, and/or other models, such as that constructed at block 303, to determine one or more predicted locations and/or other information. The results of the application of the models can be output at block 307, for example by being displayed to a system operator and/or appended to an analytics database. The results may additionally or alternatively be applied to further uses such as the display of targeted advertising based on the user's predicted location.

The following describes a possible algorithm for applying a model to words in a given user's messages, performed for example at block 306. This algorithm follows onto the baseline estimation model example from above described with respect to block 303. It will be understood that numerous alternate algorithms, based on this and/or other statistical, probabilistic, and predictive models, may be applied.

Given, for a user U, a set of words W_{U} extracted from that user's messages M_{U}, a model may be generated that calculates the probability of the user being in a city i as:

$$P ( i \vert {W}_{U} ) = {\sum }_{ω ∈ {W}_{U}} P ( i \vert ω ) P ( ω )$$

Where we use P(ω) to denote the probability of the word ω in the whole dataset. Letting C(ω) be the number of occurrences of the word ω, and T be the total number of tokens in the corpus, we have:

$$P ( ω ) = \frac{C ( ω )}{T}$$

The approach of the aforementioned embodiment may be used to produce a per-user city probability, and may be repeated for multiple cities across all cities. The city with the highest probability may be taken as the user's estimated location, and/or the cities with the highest probabilities may be considered, in various embodiments.

In the baseline estimation model example, the terms of users' messages are assigned to cities to which the users belong. The model as described above does not account for relations among messages, such as the reply relationship described previously. Accounting for such relations may be used, in certain embodiments, to advantageously improve the predictive accuracy of the systems and methods described herein. Although the following is described with respect to the reply relationship, it will be understood that other message-to-message relationships, message-to-user relationships, and/or other relationships may be considered and may provide similar advantages.

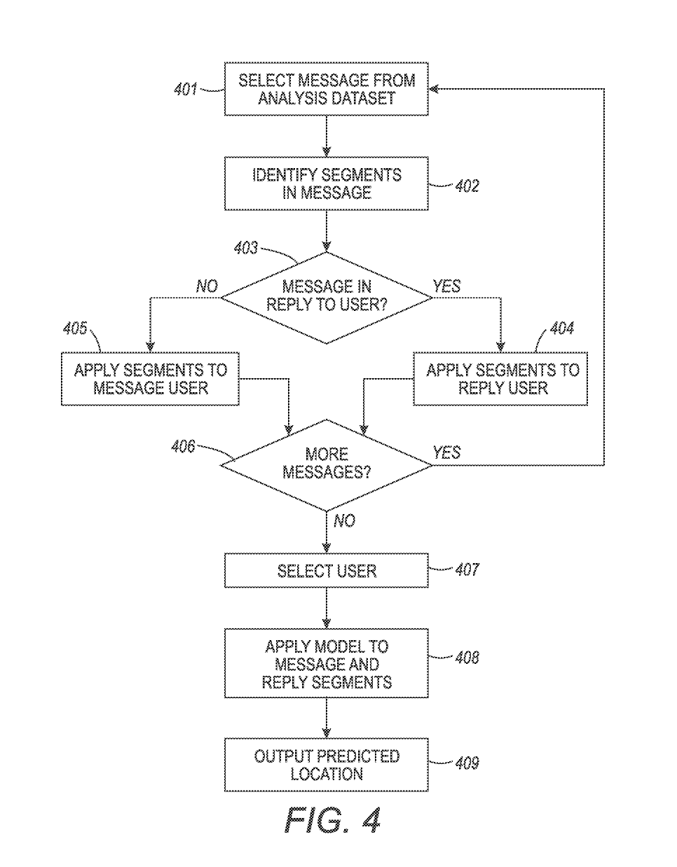

FIG. 4 is a flowchart of a process of analyzing messages, incorporating relationships among messages, as used in an embodiment. The process may be performed by computer system 101 of FIG. 1, for example, and may be performed in the analysis phase of FIG. 3, for example. The particular example process of FIG. 4, which is referred to as the “reply-based estimation model,” is described with respect to predictions of locations for users based on words in messages and reply relationships among messages. However, it will be understood that the algorithm described may be adapted to other predictions, other methods of segmenting messages, and other sorts of relationships, among other things. In various embodiments, additional blocks may be included, some blocks may be removed, and/or blocks may be connected or arranged differently from what is shown.

At block 401, a message is selected from an analysis dataset of messages and users whose location is to be estimated. At block 402, the message is then analyzed to produce a number of segments, such as words, as described above with respect to blocks 302 and 305 of FIG. 3, for example.

The segments of the message are then assigned to a user, so that those segments may be used for estimating the location of that user. At block 403, the system determines whether the message is a reply to another user. If so, the message segments of block 402 are applied to the user to whom the message was directed as a reply, at block 404. If not, the segments are applied to the user who authored the message, at block 405. In various embodiments, the segments may be allocated differently. For example, the segments may be allocated both to the author and to the reply user when the message is a reply.

In determining whether a message is a reply at block 403, messages may be categorized into at least three types. It will be understood that, depending on the nature of the messaging system, any subset of these message types may be available, and/or other message types may be available.

First, messages may be standalone messages that do not reply to other messages or users. These messages do not contain any reply-tag. The terms used in this type of message may be used to form a direct relation to the user's location in evaluating the distribution of words or other segments.

The second kind of message is one that contains a reply-tag. This type of message may be used to reply to a certain message posted by another user. The reply message may be directed to the user who posted the original message. This message may be identified by containing a reply tag at the beginning of the message, by including reply metadata, and/or by other means.

The third type of message is a message that is directed to a user, but it not necessarily a reply to a particular message of that user. This message generally may contain a reply tag in between other words of the message. It may also be a reposting of a message originally posted by another user.

These reply relationships form the basis of a conversation between different users, so a message and its reply messages may be considered as a dialogue between the users. It is often the case that the topic of a conversation remains constant throughout the relevant reply messages, so we can relate the words or other segments of the messages in the conversation to the topic of the conversation. The conversation may involve location-specific words related to the topic. Thus, instead of always assigning the words used in the message to the user who posted the message, the words occurring in the complete conversation may be assigned to the user who initiated the conversation since the initiator may initiate a conversation topic involving the geographic location of the initiator. Thus, when a reply message is encountered in the data set, the words of that message may be assigned to the recipient of the reply message rather than to, and/or in addition to, the user who posted the reply message. With this assignment of words to different users, and in turn, to different locations to which the user belongs, the system may evaluate a probability distribution that recognizes the different types of messages and the relationships between them. Hence, the social structure of the messaging system may be advantageously considered in estimating the geographic location of a user.

Having assigned words or other segments of a message to a particular user by the aforementioned process and/or other process, at block 406 the system may determine whether there are further messages to analyze. If so, then the process returns to block 401 to consider those further messages. Otherwise, the process proceeds to aggregate or otherwise analyze the collected and assigned words, in order to make predictions of locations of users.

At block 407, a user of the messaging system is selected. At block 408, one or more probabilistic, statistical, predictive, and/or other models are applied to that user and the words collected with respect to that user, to determine a predicted location. The model may be one constructed as in the training phase described with respect to FIG. 3, for example. At block 409, the predicted locations and/or other information may be presented or used for further computations.

Sample code for the reply-based estimation model, as used in an embodiment, is provided in the following code listing.

Inputs:
messages: list of messages to be analyzed
cities: list of locations, e.g. cities in US with at least 5000 people
distributions: probability distributions relating words to cities
k: number of cities to return for each user
Outputs:
estimatedCities: top k estimated cities for each user

| | |
|---|---|
| 1 | for message in messages do: |
| 2 | terms = parseAndNormalizeWords(message.words) |
| 3 | if message.isReplyMessage? |
| 4 | users[message.replyToUser].terms.addTerms(terms) |
| 5 | else |
| 6 | users[message.authoringUser].terms.addTerms(terms) |
| 7 | end if |
| 8 | next message |
| 9 | for user in users do: |
| 10 | for city in cities do: |
| 11 | user.likelihoodForCities[city] = 0 |
| 12 | for term in user.terms do: |
| 13 | user.likelihoodForCities[city] += \ |
| | distributions[term][city] * term.count |
| 14 | next term |
| 15 | next city |
| 16 | next user |
| 17 | for user in users do: |
| 18 | estimatedCities[user] = \ |
| | cities.sortBy(user.likelihoodForCities).chooseTop(k) |
| 19 | next user |
| 20 | return estimatedCities |

The input for the above example algorithm is list of messages, a list of cities from the training dataset, and a distribution of terms with their count and frequency, from the training dataset. In line #1 the algorithm loops through each message. In line #2, the algorithm parses the words and normalizes the words to identify terms or other segments. As a key advantage of the algorithm is the consideration of reply relationships, in line #3, the algorithm checks whether the message is a reply or not. For a particular messaging system that identifies replies with an at-symbol followed by a username, this determination may be based on searching the message for a word of this format (“@[user]”). Regarding the types of reply messages from above, the algorithm may distinguish between different types of reply messages or may treat all types of reply messages similarly. If it is a reply message, the algorithm assigns the terms of the message to the user to whom the reply was directed. Hence, between line #3 and #7, the algorithm builds a list of users and their corresponding normalized terms from their messages and replies. This list of users and terms can be used in next level of location estimation.

In line #9, the algorithm loops through all users that were obtained previously, and in line #10 it loops through the list of cities or other locations. In line #13, the algorithm assigns scores for user-city pairs by calculating the sum of relevant term frequencies for the city-term pair multiplied by the number of occurrences of that term. At the end of line #16, the algorithm produces collective information about each user and a probable list of cities with estimated score values. The higher score for a city represents a higher estimated likelihood that the user is in that city.

As can be seen, the complexity of the aforementioned algorithm is based on the number of terms in all messages, the number of unique terms in the term dictionary, the number of cities, and the number of users per city. The complexity applies both to the baseline estimation model and the reply-based estimation model.

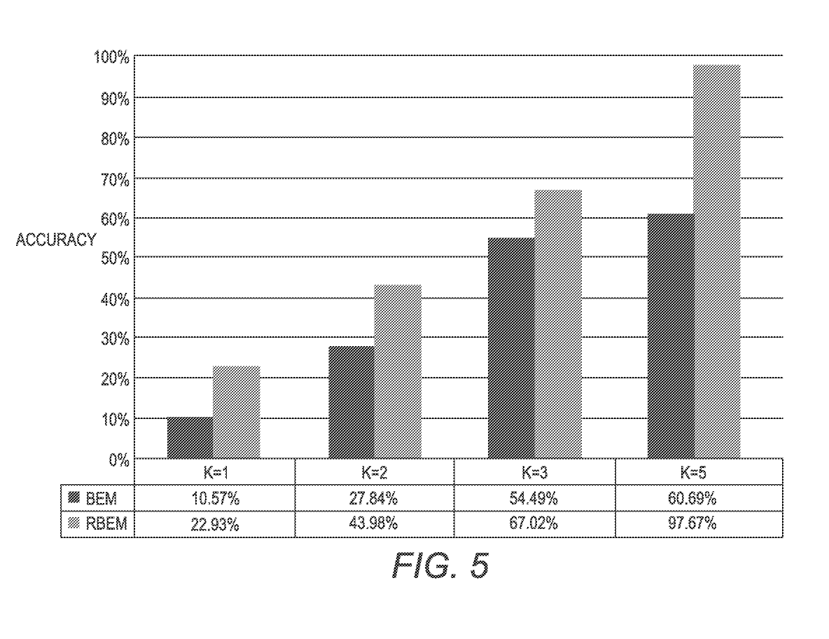

FIG. 5 is a graph of experimental data assessed from an implementation of the algorithms described in this specification. The experiment used a sample of about 1000 messages from Twitter, where those messages were associated with 738 users. When the baseline estimation model was applied, it was found that about 10.57% of users were assigned an estimated location within 1000 miles of their original location. However, by using the reply-based estimation model, we found that 22.93% of same users were assigned a location within 100 miles of their original location. Estimation accuracy can easily be improved by increasing the number of estimated locations (k in the above algorithm), as displayed in FIG. 5.

### Example Computer System

FIG. 6 illustrates a computer system 600 that is consistent with embodiments of the present teachings. In general, embodiments of the aforementioned systems and methods may be implemented in various computer systems, such as a personal computer, a server, a workstation, an embedded system, or a combination thereof, for example, computer system 600. Certain embodiments of the P2P module may be embedded as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. However, for purposes of explanation, system 600 is shown as a general purpose computer that is well known to those skilled in the art. Examples of the components that may be included in system 600 will now be described.

As shown, system 600 may include at least one processor 615, a keyboard 617, a pointing device 618 (e.g., a mouse, a touchpad, and the like), a display 616, main memory 610, an input/output controller 614, and a storage device 619. Storage device 619 can comprise, for example, RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. A copy of the computer program embodiment of the system can be stored on, for example, storage device 619. System 600 may also be provided with additional input/output devices, such as a printer (not shown). The various components of system 600 communicate through a system bus 612 or similar architecture. In addition, system 600 may include an operating system (OS) 620 that resides in memory 610 during operation. One skilled in the art will recognize that system 600 may include multiple processors 615. For example, system 600 may include multiple copies of the same processor. Alternatively, system 600 may include a heterogeneous mix of various types of processors. For example, system 600 may use one processor as a primary processor and other processors as co-processors. For another example, system 600 may include one or more multi-core processors and one or more single core processors. Thus, system 600 may include any number of execution cores across a set of processors (e.g., processor 615). As to keyboard 617, pointing device 618, and display 616, these components may be implemented using components that are well known to those skilled in the art. One skilled in the art will also recognize that other components and peripherals may be included in system 600.

Main memory 610 serves as a primary storage area of system 600 and holds data that is actively used by applications, running on processor 615. One skilled in the art will recognize that applications are software programs that each contains a set of computer instructions for instructing system 600 to perform a set of specific tasks during runtime, and that the term “applications” may be used interchangeably with application software, application programs, and/or programs in accordance with embodiments of the present teachings. Memory 610 may be implemented as a random access memory or other forms of memory as described below, which are well known to those skilled in the art.

OS 620 is an integrated collection of routines and instructions that are responsible for the direct control and management of hardware in system 600 and system operations. Additionally, OS 620 provides a foundation upon which to run application software. For example, OS 620 may perform services, such as resource allocation, scheduling, input/output control, and memory management. OS 620 may be predominantly software, but may also contain partial or complete hardware implementations and firmware. Well known examples of operating systems that are consistent with the principles of the present teachings include MICROSOFT WINDOWS (e.g., WINDOWS CE, WINDOWS NT, WINDOWS 2000, WINDOWS XP, and WINDOWS VISTA), MAC OS, LINUX, UNIX, ORACLE SOLARIS, OPEN VMS, and IBM AIX.

The foregoing description is illustrative, and variations in configuration and implementation may occur to persons skilled in the art. For instance, the various illustrative logics, logical blocks, modules, and circuits described in connection with the embodiments disclosed herein may be implemented or performed with a general purpose processor (e.g., processor 602), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

If implemented in software, the functions may be stored on or transmitted over a computer-readable medium as one or more instructions or code. Computer-readable media includes both tangible computer storage media and communication media including any medium that facilitates transfer of a computer program from one place to another. A storage media may be any available tangible media that can be accessed by a computer. By way of example, and not limitation, such tangible computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Resources described as singular or integrated can in one embodiment be plural or distributed, and resources described as multiple or distributed can in embodiments be combined. The scope of the present teachings is accordingly intended to be limited only by the following claims.

Other embodiments will be apparent to those skilled in the art from consideration of the specification and practice of the embodiments disclosed herein. It is intended that the specification and examples be considered as exemplary only.

What is claimed is:

1. A method of analyzing message data including a plurality of messages associated with one or more users, the method being performed using a computer system comprising a computer storage medium and a computer processor, the method comprising:
parsing each message of the plurality of messages to identify a plurality of message segments;
assigning the message segments to the one or more users, the assignment being based at least in part on a determination of whether each message of the plurality of messages is a reply message, the segments of the message being assigned to a reply user if the message is determined to be a reply message;
applying a statistical model to the assigned message segments, to determine predicted locations for the users; and
outputting the predicted locations for the users.

2. The method of claim 1, wherein parsing each message of the plurality of messages to identify a plurality of message segments comprises identifying one or more words of the plurality of messages.

3. The method of claim 2, wherein identifying one or more words of the plurality of messages comprises canonicalizing at least one word of the one or more words.

4. The method of claim 1, wherein the determination of whether each message of the plurality of messages is a reply message comprises determining whether the message includes a reply tag within the text of the message.

5. The method of claim 4, wherein the determination of whether the message includes a reply tag comprises identifying a user identification symbol within the message.

6. The method of claim 1, wherein the segments of the message are assigned to the author of the message if the message is determined not to be a reply message.

7. The method of claim 1, wherein the statistical model comprises a plurality of distribution values associating message segments with locations.

8. The method of claim 7, wherein applying the statistical model to the assigned message segments comprises computing an aggregated distribution value based on a subset of the plurality of distribution values associated with the assigned message segments.

9. The method of claim 7, wherein at least one of the subset of the plurality of distribution values is associated with a message segment identified in a reply message.

10. The method of claim 1, wherein the statistical model is computed based on a training dataset comprising training users, training messages, and training locations.

11. The method of claim 10, wherein the training locations include latitude and longitude coordinates.

12. The method of claim 10, wherein the training locations are determined to be obtained from a computer-generated source rather than from a user-provided source.

13. The method of claim 10, wherein the statistical model is computed based at least in part on a maximum likelihood estimation.

14. The method of claim 1, wherein the statistical model is configured to estimate the probability of a user being in a location based on the formula:
$$P ( i \vert {W}_{U} ) = {\sum }_{ω ∈ {W}_{U}} P ( i \vert ω ) P ( ω )$$
where i represents the location, W_{U} represents a set of words associated with the user, and P(ω) represents a probability associated with a word ω.

15. The method of claim 14, wherein P(ω) is calculated as:
$$P ( ω ) = \frac{C ( ω )}{T}$$
where C(ω) is a count associated with ω and T is a total number of words.

16. The method of claim 1, wherein outputting the predicted locations for the users comprises presenting targeted advertising to the users based at least in part on the predicted locations.

17. A computer system configured to analyze messages, comprising:
a computer storage medium having stored thereon a plurality of messages associated with one or more users;
a computer processor configured to execute one or more software modules;
a parsing module configured to parse each message of the plurality of messages to identify a plurality of message segments;
an assignment module configured to assign the message segments to the one or more users, the assignment being based at least in part on a determination of whether each message of the plurality of messages is associated with an associated user, the segments of the message being assigned to the associated user if the message is determined to be associated with the associated user;
a statistical modeling module configured to apply a statistical model to the assigned message segments, to automatically generate predictions for the users; and
an output module configured to output the predictions for the users.

18. A non-transitory computer-readable medium having stored thereon a plurality of executable software modules configured to be executed on a computer system having a computer processor, the plurality of executable software modules comprising:
a parsing module configured to parse each message of a plurality of messages to identify a plurality of message segments;
an assignment module configured to assign the message segments to one or more users, the assignment being based at least in part on a determination of whether each message of the plurality of messages is associated with an associated user, the segments of the message being assigned to the associated user if the message is determined to be associated with the associated user;
a statistical modeling module configured to apply a statistical model to the assigned message segments, to automatically generate predictions for the users; and
an output module configured to output the predictions for the users.
